(19) United States
(12) Patent Application Publication
(10) Pub. No.: US 2009/0135442 A1
(43) Pub. Date: May 28, 2009

(54) SCANNING DEVICE HAVING VIRTUAL TRAYS INTO WHICH MEDIA SHEETS ARE LOADED FOR PRINTING COPY JOBS INITIATED AT THE SCANNING DEVICE

(76) Inventors: Steven Harold Taylor, Boise, ID (US); William Robert Cridland, Boise, ID (US); Michael James Shelton, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/243,434

(22) Filed: Oct. 1, 2008

Related U.S. Application Data
(60) Provisional application No. 60/989,926, filed on Nov. 24, 2007.

(51) Int. Cl. G06F 3/12; H04N 1/04

(52) U.S. Cl. 358/1.13; 358/1.15; 358/498

(57) ABSTRACT

A scanning device receives selection of a given tray in relation to which a copy job is to be printed. The given tray is associated with attributes of media sheets loaded thereinto, and is associated with specific printing capabilities of a printing device of which the given tray is physically a part. The given tray is selected from a group of trays including at least virtual trays. Each virtual tray corresponds to a physical tray of a printing device other than the scanning device. The scanning device receives selection of characteristics of the copy job. The characteristics are selected from a group of characteristics encompassing all characteristics supported by the given tray. The scanning devices scans media sheets loaded thereinto to yield a file. The scanning device causes the file to be printed based on the characteristics selected. The file is printed on media sheets loaded into the given tray.

### BACKGROUND

Multi-function printing (MFP), or all-in-one (AIO), devices can include printing and scanning functionality. Printing is the process of generating a hardcopy of an image that currently exists electronically, and scanning is the process of generating an electronic version of an image that currently exists in hardcopy form. Such devices can act as copiers. For instance, a user can cause such a device to scan media sheets already having images formed thereon and then to print the images on blank media sheets.

However, at least some such MFP devices have scanning functionality that exceeds their corresponding printing functionality, or otherwise have limited printing functionality. For example, an MFP device may be able to scan in color, but not be able to print in color. As another example, an MFP device may not be able to perform automatic duplexing while printing. Users of MFP devices are therefore sometimes limited in the types of copy jobs that they can perform with these devices.

### BRIEF DESCRIPTION OF THE DRAWINGS

FIG. 1 is a flowchart of a method, according to an embodiment of the present disclosure.

FIG. 2 is a diagram of a system in relation to which the method of FIG. 1 can be performed, according to an embodiment of the present disclosure.

FIG. 3 is a diagram of an example user interface of a scanning device via which a user is able to select a tray in relation to which a copy job is to be printed, according to an embodiment of the present disclosure.

FIG. 4 is a diagram of an example user interface of a scanning device via which a user is able to select characteristics of a copy job, according to an embodiment of the present disclosure.

FIG. 5 is a block diagram of a rudimentary scanning device that can perform the method of FIG. 1, according to an embodiment of the present disclosure.

### DETAILED DESCRIPTION OF THE DRAWINGS

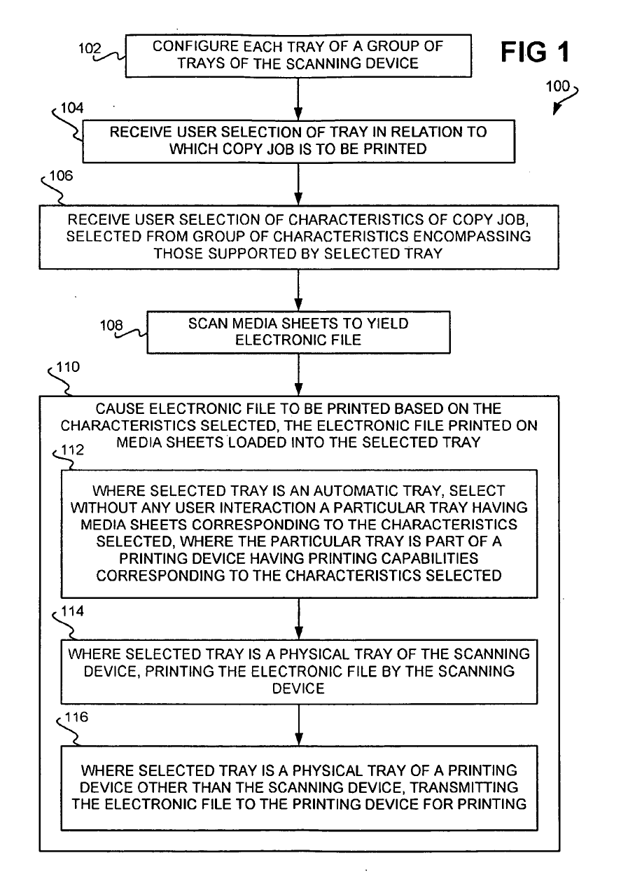

FIG. 1 shows a method 100, according to an embodiment of the present disclosure. The method 100 is performed by a scanning device. The scanning device may be a standalone scanning device that just has scanning functionality, and that does not have, for instance, printing functionality. The scanning device may also be a multi-function printing (MFP) or all-in-one (AIO) device that has at least scanning functionality and also printing functionality.

The method 100 can be implemented as one or more computer programs stored on a computer-readable medium. The computer-readable medium may be a storage device, such as a hard disk drive or another type of magnetic media, an optical disc or another type of optical media, a semiconductor memory or another type of semiconductor media, or another type of computer-readable media. In one embodiment, the computer-readable medium may be or include the firmware of the scanning device.

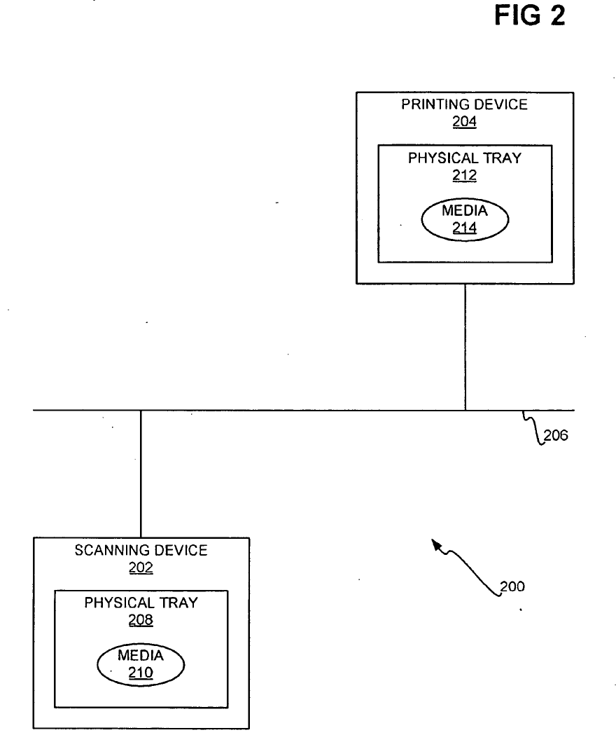

FIG. 2 shows a system 200 in relation to which the method 100 can be performed, according to an embodiment of the present disclosure. The system 200 includes at least a scanning device 202 and a printing device 204, which are communicatively connected to one another over a network 206. The scanning device 202 may be the scanning device that has been described, and as such may be a standalone scanning device or an MFP or an AIO device.

Similarly, the printing device 204 may be a standalone printing device that has printing functionality, and that does not have, for instance, scanning functionality. The printing device 204, however, may also be an MFP or an AIO device that has at least printing functionality and also scanning functionality. The network 206 may be or include a local-area network (LAN), a wide-area network (WAN), an Ethernet network, a wired network, a wireless network, a telephony network, and/or another type of network.

It is noted that the method 100 can be completely performed by the scanning device 202 without any assistance from a computer device—typically, a desktop computer or a laptop computer—other than the scanning device 202 and the printing device 204. That is, the scanning device 202 can perform the method 100 without having to employ a computer device, other than itself, which does not or may not have direct printing functionality. For instance, desktop and laptop computers typically do not have direct printing functionality, in that these computer devices themselves cannot print images on media sheets, but rather can just transmit images to other devices, such as the printing device 204, for printing on media sheets.

In the embodiment of FIG. 2, the scanning device 202 is specifically a scanning device that also has printing functionality. As such, the scanning device 202 includes a physical tray 208 in which media sheets 210 are loaded. The scanning device 202 can print images—i.e., such as text, graphics, and so on, on sheets of media like paper—on the media sheets 210. In this respect, the scanning device 202 has direct printing functionality, in that the device 202 can itself print on the media sheets 210 loaded into the physical tray 208, as opposed to having to use another device, such as the printing device 204, to print. Because the scanning device 202 has printing functionality, it can also be referred to as a printing device.

The media sheets 210 loaded into the physical tray 208 of the scanning device 202 have attributes. Such attributes can include the size of the media sheets 210 (e.g., letter size, legal size, and so on), as well as the type of the media sheets 210 (e.g., plain paper, glossy paper, letterhead, and so on), among other types of attributes. The scanning device 202, in the embodiment of FIG. 2, also has specific printing capabilities. Such printing capabilities can include that the scanning device 202 is only able to print in black-and-white (as opposed to also being able to print in color), that the scanning device 202 is not able to automatically perform duplexing while printing (as opposed to being able to automatically perform duplexing while printing), among other types of printing capabilities.

The scanning device 202 is communicatively connected to the printing device 204 in that the scanning device 202 can directly communicate with the printing device 204 without having to employ an intermediary computer device—typically, a desktop computer or a laptop computer—between the devices 202 and 204. That is, the scanning device 202 can directly send an electronic file or other data to the printing device 204 for printing. The scanning device 202 in this sense does not have to first send the electronic file or other data to another computer device, such as a desktop or laptop computer, where this computer device would then have to send the electronic file received from the scanning device 202 to the printing device 204.

The printing device 204 also has a physical tray 212 in which media sheets 214 are loaded. The printing device 204 can print images on the media sheets 214. In this respect, the printing device 204 also has direct printing functionality, in that the device 204 can itself print on the media sheets 214 loaded into the physical tray 212, as opposed to having to use another device to print. The media sheets 214 loaded into the physical tray 212 of the printing device 204 also have attributes, and the printing device 204 also has specific printing capabilities. As an example of the latter, the printing device 204 may be able to print in color (as opposed to just in black-and-white), and may be able to automatically perform duplexing while printing.

The embodiment of FIG. 2 is representative of embodiments of the present disclosure. As such, while just one printing device 204 is depicted as being communicatively connected to the scanning device 202, in other embodiments there can be more than one such printing device. Such printing devices, including the printing device 204, are separate from (i.e., different devices than) the scanning device 202. Furthermore, while the devices 202 and 204 are depicted as each having just one physical tray, in other embodiments one or more of these devices can have more than one physical tray. For example, typically each device may also at least have a manual-feed tray, in which media sheets can be manually fed into the device for printing images thereon.

Referring back to FIG. 1, the method 100 is described in relation to the system 200 that has been described. The scanning device 202 thus configures each tray of a group of trays of the scanning device 202 (102). The group of trays of the scanning device 202 includes actual physical trays that are a part of the scanning device 202 itself, as well as virtual trays. Virtual trays are physical trays that are part of printing devices other than the scanning device 202. Thus, a virtual tray of the scanning device 202 is a tray that is not physically a part of the scanning device 202, but rather is physically a part of a printing device other than the scanning device 202. For example, the physical tray 212 of the printing device 204 can be a virtual tray of the scanning device 202.

Each tray of the scanning device 202 is configured so that it is associated with the attributes of the media sheets loaded into the tray, and also so that it is associated with the specific printing capabilities of the printing device of which the tray is physically a part. For example, the physical tray 208 may be configured so that it is associated with plain letter-sized paper as the attributes of the media sheets 210 loaded into the tray 208. The physical tray 208 may also be configured so that it is associated with black-and-white, no-duplex printing, which are the specific printing capabilities of the scanning device 202.

By comparison, the physical tray 212 of the printing device 204 may be configured as a virtual tray of the scanning device 202 so that it is also associated with plain letter-sized paper as the attributes of the media sheets 214 loaded into the tray 214. The physical tray 212 may also be configured as a virtual tray of the scanning device 202 so that it is associated with color or black-and-white printing, and duplex or no-duplex printing, which are the specific printing capabilities of the printing device 204. To this extent, the scanning device 202 has one physical tray 208 and one virtual tray, the latter corresponding to the physical tray 212 of the printing device 204.

A composite, automatic tray of the scanning device 202 may also be part of the group of trays and thus may be configured. The automatic tray is a composite tray in that it encompasses and is associated with the media sheet attributes of all the other trays of the scanning device 202—including virtual trays—and is associated with the printing capabilities of the printing devices of all these other trays. The automatic tray may be a default tray that is automatically selected if the user does not particularly specify a given tray having media sheets on which printing should occur.

Configuration of the group of trays in part 102 can be performed in one or more of two different ways. First, a user, such as an administrator or another type of user, may manually configure each tray of the scanning device 202. This manual configuration may include manually specifying the attributes of the media sheets 210 loaded into the physical tray 208, and/or manually specifying the printing capabilities of the scanning device 202. This manual configuration may also include manually specifying printing devices having trays that should be included as virtual trays of the scanning device 202, such as the printing device 204 having the physical tray 212. In such instance, the administrator or other user may further specify the attributes of the media sheets 214 loaded into the physical tray 212, and the printing capabilities of the printing device 204.

Second, configuration of the group of trays in part 102 may be performed automatically, without any user interaction. For example, the scanning device 202 may be preprogrammed with its specific printing capabilities, and may be able to detect the attributes of the media sheets 210 loaded into the physical tray 208, or specify default attributes for these media sheets 210. The scanning device 202 may further be able to, as can be appreciated by those of ordinary skill within the art, discover separate printing devices on the network 206, such as the printing device 204. Once these printing devices are discovered, the scanning device 202 may be able to query these printing devices to learn the number of physical trays they have, the attributes of the media sheets loaded into these trays, and the printing capabilities of these printing devices, as can also be appreciated by those of ordinary skill within the art.

The scanning device 202 receives selection by a user of a tray in relation to which a copy job is to be printed (104). The tray is selected from the group of trays that has been configured, and thus can include actual physical trays of the scanning device 202, as well as virtual trays of the scanning device 202, which are physical trays of printing devices other than the scanning device 202. The tray selected can also include the automatic tray that has been described as encompassing and being associated with the attributes of the media sheets loaded into all the other trays, and the printing capabilities of the printing devices having all these other trays.

A copy job is a type of scan and print job in which one or more media sheets having images already formed (such as already printed) thereon are directly scanned by the scanning device 202 to generate an electronic file digitally representing these images. Then, the electronic file is printed on other, blank media sheets. As such, a copy of the former media sheets is made on the latter media sheets.

The user can select the tray in part 104 explicitly or implicitly. As to explicit selection, the user can actively (i.e., explicitly) choose the tray from the group of trays, specifically specifying which tray of the group of trays should be used for the copy job. As to implicit selection, there may be a default tray, such as the automatic tray, which is pre-selected for the user. If the user does not override this default tray by explicitly selecting a different tray, then it is said that the user has implicitly selected this default tray of the group of trays.

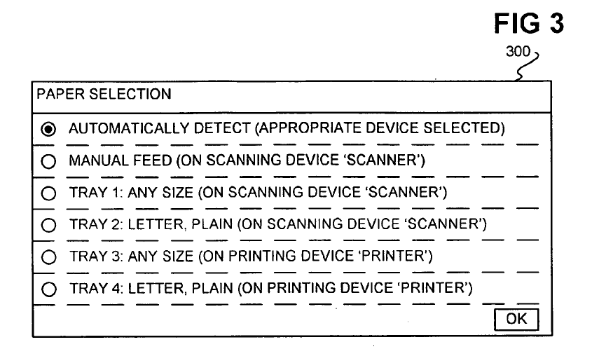

FIG. 3 shows an example user interface by which the scanning device 202 can receive implicit or explicit user selection of the tray in which a copy job is to be printed, according to an embodiment of the present disclosure. Specifically, FIG. 3 shows a window 300 that is displayed on a display of the scanning device 202. The display may be a touch-sensitive display, so that the user can make his or her select by pressing a finger or other implement against the display in the appropriate location. Alternatively, the scanning device 202 may include one or more buttons, keys, or other actuable controls that can be actuated by the user to implicitly or explicitly select the tray.

In one embodiment, the window 300 may not even be displayed unless the user specifically selects an option on the scanning device 202 to display the window 300. In this instance, the user implicitly selects the tray in which a copy job is to be printed. This tray may be the tray the user most recently selected for a previous copy job or another type of job, or the tray may be the default tray, which such as the automatic tray.

Where the window 300 is displayed, the user is able to select one of the trays displayed within the window 300. If there are more trays than are able to displayed within the window 300 at the same time, a scroll bar or other user interface object may be displayed on the window 300 so that the user can scroll through all the available trays, as can be appreciated by those of ordinary skill within the art. For each tray, the identification of the tray is displayed within the window 300, such as by its attributes and/or the device in which the tray is physically located (i.e., the device of which the tray is a part). The device may be identified by name and/or location.

For example, the first tray is the automatic tray, which is indicated as already being selected. As such, the window 300 is displayed so that this default tray, or this previously selected tray, is indicated as being selected, which in FIG. 3 is the automatic tray. In one embodiment, it may be said that the user implicitly selects this tray if he or she selects the “OK” button without explicitly selecting a different tray, other than this default or previously selected tray.

The second, third, and fourth trays displayed in the window 300—including the two trays numbered one and two in FIG. 3—are trays that are physical trays of the scanning device 202 itself. The second tray is a manual feed tray in which the user manually feeds media sheets to be printed on, and the third tray is a non-manual feed tray in which “any size” (and any type) of media sheet has already been loaded. The fourth tray is a non-manual feed tray in which letter-sized, plain media sheets have already been loaded.

The fifth and sixth (i.e., last) trays displayed in the window 300—numbered three and four in FIG. 3—are trays that are physical trays of the printing device 204. The fifth tray is a non-manual feed tray in which “any size” (and any type) of media sheet has already been loaded. The fourth tray is a non-manual feed tray in which letter-sized, plain media sheets have already been loaded. Thus, if the user explicitly selects a tray other than the first tray—overriding the previous or default selection of the first tray—and then selects the “OK” button, it is said that the user has explicitly selected a tray in one embodiment.

Those of ordinary skill within the art can appreciate the difference between a manual feed tray and a non-manual feed tray. A non-manual feed tray typically can have more media sheets loaded therein than a manual feed tray can. A non-manual feed tray can be in the form of a drawer, which is pulled from the device in question in order to load a relatively large number of media sheets, and which is then pushed back into the device. By comparison, a manual feed tray can be in a non-drawer form, such as a relatively flat piece of plastic or another material, that is pulled downwards from the device so that a relatively small number of media sheets can be loaded thereon, and from which any remaining media sheets are typically removed after printing and which is finally pushed back towards the device so that it is substantially flush with the device. There can be additional and/or other differences between manual feed and non-manual feed trays as well.

Referring back to FIG. 1, the scanning device 202 receives selection by the user of the characteristics of the copy job (106). The user from which the selection is received in parts 104 and 106 may be the same or a different user that performed any manual configuration in part 102. The characteristics of the copy job that are available to be selected by the user are those that encompass the characteristics supported by the tray that has been selected implicitly or explicitly in part 104. For the automatic tray, the characteristics of the copy job that are available to be selected by the user are those that encompass the characteristics supported by all the trays of the scanning device 202, including virtual trays of the device 202.

For example, printing characteristics may include whether automatic duplexing is to be performed when printing the copy job, whether scanning and printing are to be performed in black-and-white in color, and so on. If the user had selected the fourth tray in the user interface of FIG. 3, corresponding to letter-sized, plain media sheets loaded into tray two that is physically a part of the scanning device 202 itself, then the user would not be able to select automatic duplexing or color printing, because the printing capabilities with which this tray is associated—those of the device 202—do not support automatic duplexing and color printing. By comparison, if the user had selected the sixth tray in the user interface of FIG. 3, corresponding to letter-sized, plain media sheets loaded into tray four that is physically a part of the printing device 204, then the user would be able to select automatic duplexing and/or color printing, because the printing capabilities with which this tray is associated—those of the device 204—do support automatic duplexing and printing.

The user can select the characteristics of the copy job in part 106 explicitly or implicitly. As to explicit selection, the user can actively (i.e., explicitly) choose or specify the characteristics. As to implicit selection, there may be default characteristics or previously selected characteristics that are pre-selected for the user. If the user does not override these characteristics—that is, the user has not explicitly selected any other characteristics—then it is said that the user has implicitly selected the characteristics in question.

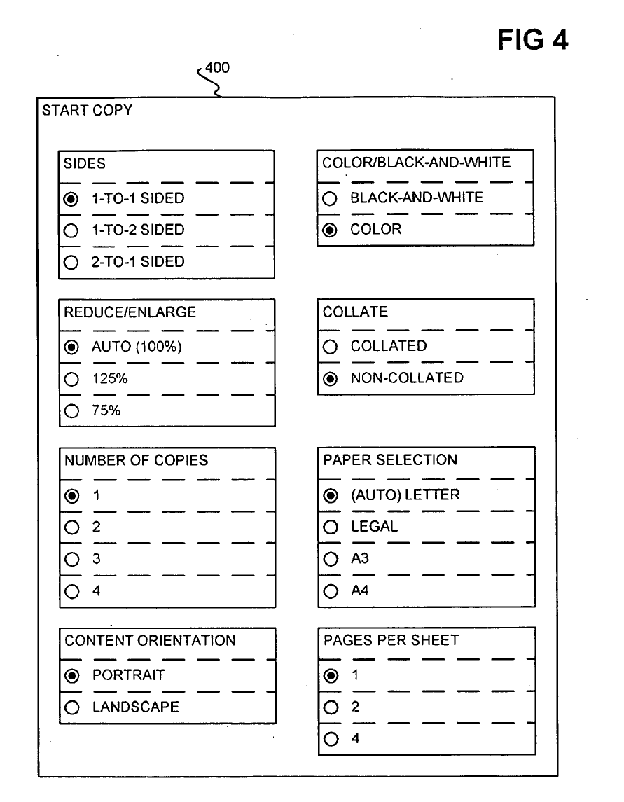

FIG. 4 shows an example user interface by which the scanning device 202 can receive implicit or explicit user selection of characteristics of the copy job to be printed, according to an embodiment of the present disclosure. Specifically, FIG. 4 shows a window 400 that is displayed on a display of the scanning device 202, such that the user interacts with the window 400 in one of the manners that have been described in relation to the window 300 of FIG. 3. The window 400 is depicted in FIG. 4 such that all the different characteristics that can be selected are displayed within the window 400 at the same time. However, if there are more characteristics that are able to be displayed within the window 400 at the same time, a scroll bar or other user interface object may be displayed on the window 400 so that the user can scroll through all the available characteristics.

As can also be appreciated by those of ordinary skill within the art, the user interface of FIG. 4 (as well as that of FIG. 3) is an example user interface, and does not limit embodiments of the present disclosure. For instance, the window 400 is depicted such that for each different type of characteristic, all the characteristic values that can be assigned to this characteristic type are displayed at same time, for all characteristic types. However, in other embodiments, just the current characteristic value for each characteristic type may be displayed, and to select a different characteristic value, a user may interact with the user interface of FIG. 4 so that a drop-down menu appears that show the different characteristic values for the characteristic type in question, where the menu may further be scrollable. Once the user has selected the same or different characteristic value for the characteristic type under consideration, he or she may then be able to cause a drop-down menu to be displayed for a different characteristic type, for instance, as can be appreciated by those of ordinary skill within the art.

Eight characteristic types are depicted in FIG. 4. Four of these characteristic types are the number of sides of the copy job, whether the copy job is to be printed in color or black-and-white, and how to reduce or enlarge the copy job. The other four of these characteristic types are whether the copy job is to be collated during printing, the number of copies to be printed, the size of paper to be printed on, the orientation of the content on the originals to be copied, and the number of pages of the originals to be printed on each sheet. Those of ordinary skill within the art can appreciate that other characteristic types can be provided as well, in addition to and/or in lieu of those depicted in FIG. 4.

The number of sides characteristic type specifies the number of sides of each media sheet that is to be scanned and the number of sides of each media sheet that is to be printed as part of the copy job. For example, the characteristic value “1-to-1 sided” indicates scanning of just one side of each media sheet to be scanned, and printing of just one side of each media sheet to be printed when copying the former to the latter. Thus, both the original media sheets to be copied each has an image on one side, and the typically blank media sheets will each be printed on just one side. By comparison, “1-to-2 sided” indicates that duplexing will occur during printing of the copy job. Thus, although the original media sheets to be copied each has an image on just one side, the typically blank media sheets will each be printed on both sides. Finally, “2-to-1 sided” indicates that scanning of both sides of the original media sheets is to occur, but that the typically blank media sheets will each be printed on just one side.

It is noted that if the second, third, or fourth tray in the window 300 of FIG. 3 has been selected by the user—i.e., a physical tray of the scanning device 202, which does not have automatic duplexing printing capabilities—then the characteristic value “1-to-2 sided” may not be displayed in the window 400 of FIG. 4. This is because the scanning device 202 does not support automatic duplexing when printing, so it does not make sense to offer this option to the user as a characteristic of the copy job. By comparison, if the user selects a virtual tray of the scanning device 202 that corresponds to a physical tray of the printing device 204, or selects the automatic tray, then the characteristic value “1-to-2 sided” is displayed in the window 400 of FIG. 4, because the printing device 204 supports duplex printing.

The color/black-and-white characteristic type specifies whether the copy job is to be printed in color or in black-and-white. If the user has selected a physical tray of the scanning device 202 in part 104, then the color characteristic value may not be displayed in the window 400, because the scanning device 202 does not have color printing capabilities. By comparison, if the user has selected the automatic tray or a virtual tray corresponding to a physical tray of the printing device 204 in part 104, then the color characteristic value is displayed in the window 400, because the printing device 204 supports color printing.

The reduce/enlarge characteristic type specifies how much the scanned media sheet images are to be reduced or enlarged when printing them on different (e.g., blank) media sheets. The percentages depicted in FIG. 4 are in relation to the original images on the scanned media sheets, such that 75% corresponds to a reduction in size by 25%, and 125% corresponds to an enlargement in size by 25%. If the tray selected by the user in part 104 is associated with printing capabilities that do not support such reducing and/or enlarging, one or more of these characteristic values—or the characteristic type as a whole—may not be displayed in the window 400.

The collate characteristic type specifies whether the copies of the original images on the scanned media sheets are to be collated or are to not be collated. For example, there may be three media sheets that have images to be scanned, numbered one-two-three. If two copies of these media sheets are printed as part of the copy job, then collation means that the copies are printed as follows: sheets one through three of copy one, followed by sheets one through three of copy two. By comparison, if the two copies are not collated, they are printed as follows: sheet one of copy one, sheet one of copy two, sheet two of copy one, sheet two of copy two, sheet three of copy one, and sheet three of copy two. If the tray selected by the user in part 104 is associated with printing capabilities that do not support collated printing, then the corresponding characteristic value may not be displayed in the window 400.

The number of copies characteristic type specifies the number of copies to be printed of the original images on the scanned media sheets, such as one, two, three, and four copies as examples. This characteristic type may in one embodiment be set to any of these characteristic values, regardless of the tray selected by the user in part 104. The paper selection characteristic type specifies the size of the media sheet to be printed on during the copy job, such as letter size, legal size, A3 size, A4 size, and so on. If the tray selected by the user in part 104 is associated with a media sheet attribute that particularly specifies a given media sheet size, then the characteristic values corresponding to sizes other than this given size may not be displayed in the window 400.

The content orientation characteristic type specifies whether the images on the original media sheets to be scanned are orientated in portrait (i.e., long side down, short side across) or landscape (i.e., short side down, long side across) format, as can be appreciated by those of ordinary skill within the art. This characteristic type may in one embodiment be set to any of these characteristic values, regardless of the tray selected by the user in part 104. The pages per sheet characteristic type specifies the number of original images on the scanned media sheets that are to be printed on a given side of a (typically blank) media sheet during copying. For example, specifying two pages per sheet means that, where there are two original media sheets to be scanned, and each have a single image thereon, then the copy job results in one side of a single media sheet having both of these images printed thereon. If the tray selected by the user in part 104 is associated with printing capabilities that do not support more than one page being printed on each media sheet, then the characteristic values corresponding to more than one page being printed on each media sheet may not be displayed in the window 400.

Referring back to FIG. 1, the scanning device 202 scans the media sheets that are the subject of the copy job in question (108). Scanning the media sheets results in an electronic file being generated that digitally represents the images that are on the media sheets. Such scanning can in one embodiment be performed by optical scanning, as can be appreciated by those of ordinary skill within the art. The electronic file that is generated may be a portable document format (PDF) electronic file, or another type of electronic file.

The scanning device 202 finally causes the electronic file to be printed, based on the characteristics selected in part 106, on media sheets loaded into the tray selected in part 104 (110). In one embodiment, part 110 is performed as follows. First, if the tray selected in part 104 is the automatic tray, a particular tray is selected that has media sheet attributes corresponding to the characteristics selected in part 106, where the particular tray is part of a printing device that has printing capabilities corresponding to the characteristics selected in part 106 (112). That is, a particular tray is selected that has media sheets loaded therein that support the characteristics selected in part 106, and where the particular tray is part of a printing device that has printing capabilities that support the characteristics selected in part 106. Part 112 can be performed without any user interaction, such that the selection of a particular tray in part 112, where the automatic tray had been selected in part 104, is performed automatically without requiring any input from the user.

For example, the user may have implicitly or explicitly selected in part 106 characteristics such that the copy job is to be printed in color and duplexing is to be performed, where the user may have implicitly or explicitly selected in part 104 the automatic tray. There may be two other trays of the scanning device 202: a physical tray of the scanning device 202, and a virtual tray corresponding to a physical tray of the printing device 204. If the scanning device 202 cannot print in color and/or cannot print such that duplexing is performed, but the printing device 204 can print in color and can print such that duplexing is performed, then the scanning device 202 selects the virtual tray corresponding to the printing device 204 in part 112.

It is noted that in some situations, more than one particular tray of the scanning device 202 may satisfy the characteristics of the copy job selected in part 106. For example, the user may have implicitly or explicitly selected in part 106 characteristics such that the copy job is to be printed in black-and-white and duplexing is not to be performed, where the user has also implicitly or explicitly selected in part 104 the automatic tray. Therefore, both the physical tray of the scanning device 202, and the virtual tray corresponding to the physical tray of the printing device 204, satisfy or support these characteristics. In one embodiment, the scanning device 202 may select the physical tray of the scanning device 202 as having higher priority than the virtual tray corresponding to the physical tray of the printing device 204 in part 112 in such situations.

In other embodiments, however, other methodologies may be employed to select a particular tray in part 112 where more than one such tray satisfy the copy job characteristics selected in part 106. For example, the scanning device 202 may select the printing device—and thus a particular physical tray thereof—that is currently available and that is not currently printing a different job. As another example, the scanning device 202 may select the printing device—and thus a particular physical tray thereof—that has the fastest throughput. As a third example, the scanning device 202 may select the printing device—and thus a particular physical tray thereof—that has a lowest per-page printing cost.

Where the tray that is selected in part 104—for instance, the particular tray selected in part 112 where the selected tray is the automatic tray—is a physical tray of the scanning device 202 itself, then the scanning device 202 directly prints the electronic file itself (114). That is, the scanning device 202 does not have to have a different printing device, such as the printing device 204, print the electronic file, but rather prints the electronic file itself, without employing any other device. The scanning device 202 prints the electronic file consistent with the characteristics selected in part 106, using media sheets loaded in the physical tray thereof selected in part 104 or part 112.

By comparison, where the tray that is selected in part 104—for instance, the particular tray selected in part 112 where the selected tray is the automatic tray—is a physical tray of a printing device other than the scanning device 202, then the scanning device 202 directly transmits the electronic file to this printing device for printing (116). For example, if the tray selected in part 104 or part 112 is a virtual tray of the scanning device 202, where this virtual tray corresponds to a physical tray of the printing device 204, then the scanning device 202 transmits the electronic file to the printing device 204 for-printing. Upon receipt of the electronic file, the printing device 204 directly prints the electronic file consistent with the characteristics selected in part 106, using media sheets loaded in the physical tray thereof selected in part 104 or part 112 as a virtual tray of the scanning device 202. It is noted that the characteristics of the copy job themselves may be transmitted to the printing device 204 by the scanning device 202, as part of the electronic file or separate from the electronic file.

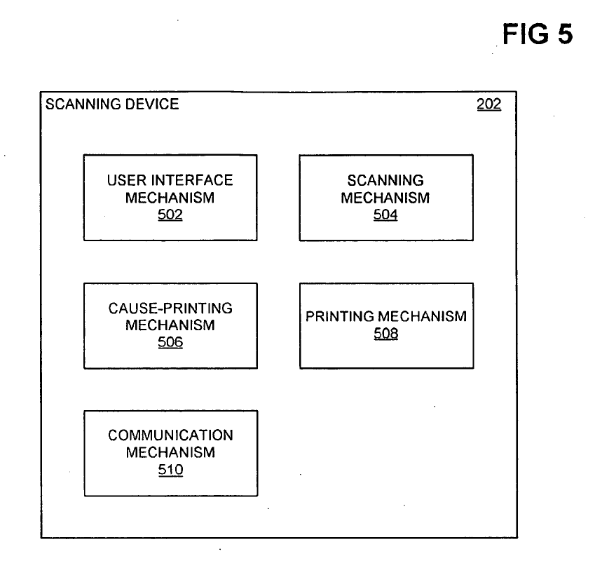

FIG. 5 is a rudimentary block diagram of the scanning device 202, according to an embodiment of the present disclosure. The scanning device 202 includes a user interface mechanism 502, a scanning mechanism 504, and what is referred to as a cause-printing mechanism 506. The scanning device 202 may also include a printing mechanism 508 and/or a communication mechanism 510.

The user interface mechanism 502 receives the implicit or explicit user selection of the tray in relation to which the copy job is to be printed, as well as the implicit or explicit user selection of the characteristics of the copy job. As such, the user interface mechanism 502 performs parts 104 and 106 of the method 100, and may also at least assist in performing part 102 of the method 100, where the configuration of part 102 is achieved manually via user interaction. The user interface mechanism 502 may be implemented in hardware, or a combination of hardware and software.

The user interface mechanism 502 may include a display and one or more input devices, as well as any other components to interact with the user. The display may be a touch-sensitive display, such as a touch screen, such that it functions as an input device as well. Alternatively, or additionally, the user interface mechanism 502 may include one or more buttons, keys, or other controls by which to receive user input.

The scanning mechanism 504 scans the media sheets loaded thereinto—and thus loaded into the scanning device 202 itself—where the media sheets already have images formed thereon. As such, the scanning mechanism 504 generates an electronic file representing the images on the media sheets, and thus performs part 108 of the method 100. The scanning mechanism 504 may be an optical scanning mechanism, including light sources, light sensors, and so on. In general, the scanning mechanism 504 is implemented in hardware or a combination of hardware and software, and includes the components by which media sheets are scanned to generate an electronic file representing the images on the media sheets. The scanning mechanism 504 provides the scanning device 202 with direct scanning functionality, in that the scanning device 202, due to the scanning mechanism 504, can scan images on media sheets without the assistance from any other device, such as a computer device like a laptop or desktop computer.

What is referred to as the cause-printing mechanism 506 performs parts 112 and 116 of part 110 of the method 100, and may be implemented in hardware, software, or a combination of hardware and software. The mechanism 506 causes the electronic file that has been generated to be printed based on the characteristics selected, using media sheets loaded into the tray selected. Thus, the mechanism 506 thus interacts with the mechanisms 502, 504, 508, and/or 510 to perform its functionality. In one embodiment, the mechanism 506 may also at least assist in performing part 102 of the method 100 as well, such that it can, for example, perform the automatic configuration of the trays of the scanning device 202.

The printing mechanism 508, when present, provides the scanning device 202 with direct printing functionality, such that the scanning device 202 is also a printing device, and such that the scanning device 202 may be considered an MFP or AIO device. The printing mechanism 508 may be a laser-printing mechanism, an inkjet-printing mechanism, or another type of printing mechanism. The printing mechanism 508 is implemented in hardware or a combination of hardware and software, and includes the components to print the electronic file that has been generated on media sheets that have been loaded into a physical tray of the scanning device 202. The printing mechanism 508 can in one embodiment be considered as including the physical tray(s) of the scanning device 202. The printing mechanism 508 performs part 114 of part 110 of the method 100.

The communication mechanism 510 communicatively connects the scanning device 202 to one or more printing devices or other devices, such as specifically the printing device 204. For instance, the communication mechanism 510 may be a wired or a wireless network adapter that communicatively connects the scanning device 202 to the network 206 to which the printing device 204 is also communicatively connected. It is said that the communication mechanism 510 provides the scanning device 202 with the capability to directly communicate with the printing device 204, because no intermediary computer device, such as a desktop or a laptop computer, is needed for the scanning device 202 to communicate with the printing device 204.

The communication mechanism 510 may be implemented in hardware, or a combination of hardware and software. The communication mechanism 510 performs part 116 of the method 100. As such, the communication mechanism transmits the electronic file that has been generated to the printing device having the physical tray to which the selected virtual tray of the scanning device 202 corresponds, as has been described in relation to the method 100.

It is noted that embodiments of the present disclosure that have been described provide for advantages over the prior art. A user may have a scanning device that does not have printing functionality, but nevertheless be able to use the scanning device to print copy jobs, without having to employ a computer device like a desktop or laptop computer. A user may have a scanning device that does have printing functionality, but that does not have certain desired printing capabilities, such as printing in color. The user is still nevertheless able to use the scanning device to print copy jobs in color, without having to employ a computer device like a desktop or laptop computer.

Furthermore, embodiments of the present disclosure extend the tray paradigm to provide for such added functionality in a way that is easy for the user to understand and employ. Typically a tray of a device corresponds to a physical tray that is a part of the device itself. By comparison, embodiments of the present disclosure extend the paradigm of a tray to include virtual trays, where the virtual trays of a device are actually physical trays of another device. Therefore, the user can easily use other printing devices to print copy jobs that are scanned by a scanning device, because such virtual trays are an extension of what the user likely already knows—the paradigm of a tray.

We claim:

1. A method performed by a scanning device, comprising:
receiving implicit or explicit selection by a user of a given tray of the scanning device in relation to which a copy job initiated at the scanning device is to be printed,
the given tray associated with attributes of media sheets loaded into the given tray, the given tray associated with specific printing capabilities of a printing device of which the given tray is physically a part,
the given tray selected from a group of trays comprising at least one or more virtual trays, each virtual tray corresponding to a physical tray of a printing device other than the scanning device and to which the scanning device is communicatively connected;
receiving implicit or explicit selection by the user of characteristics of the copy job, the characteristics selected from a group of characteristics encompassing all characteristics supported by the given tray implicitly or explicitly selected by the user;
scanning one or more media sheets loaded into the scanning device, the media sheets having images already formed thereon such that scanning the media sheets yields an electronic file digitally representing the images on the media sheets; and,
causing the electronic file to be printed based on the characteristics of the copy job as implicitly or explicitly selected by the user, the electronic file printed on media sheets loaded into the given tray implicitly or explicitly selected by the user.

2. The method of claim 1, wherein the method is performed completely by the scanning device without any assistance by a computer device other than the scanning device and other than the printing devices having the physical trays corresponding to the virtual trays of the scanning device,
wherein the scanning device has direct scanning functionality, and
wherein each printing device has direct printing functionality.

3. The method of claim 1, wherein the group of trays further comprises one or more physical trays of the scanning device, such that the scanning device is also a printing device and such that the scanning device has both direct scanning and direct printing functionality, the scanning device having specific printing capabilities.

4. The method of claim 1, wherein for each virtual tray, the scanning device is communicatively connected to the printing device having the physical tray to which the virtual tray corresponds in that the scanning device is able to directly communicate with the printing device without an intermediary computer device between the scanning device and the printing device.

5. The method of claim 1, wherein receiving implicit or explicit selection by the user of the given tray of the scanning device in relation to which the copy job initiated at the scanning device should be printed comprises receiving implicit selection by the user of the given tray of the scanning device, such that a default tray is implicitly selected by the user as the given tray due to the user not explicitly selecting one of the group of trays other than the default tray.

6. The method of claim 1, wherein receiving implicit or explicit selection by the user of the given tray of the scanning device in relation to which the copy job initiated at the scanning device should be printed comprises receiving explicit selection by the user of the given tray of the scanning device, such the user explicitly selects one of the group of trays other than a default tray.

7. The method of claim 1, wherein the attributes of media sheets loaded into the given tray comprise one or more of: a type of the media sheets loaded into the given tray, and a size of the media sheets loaded into the given tray.

8. The method of claim 1, wherein receiving implicit or explicit selection by the user of the characteristics of the copy job comprises receiving implicit selection by the user of one or more of the characteristics, such that one or more default characteristics are implicitly selected by the user as the one or more of the characteristics due to the user not explicitly selecting the one or more of the characteristics.

9. The method of claim 1, wherein receiving implicit or explicit selection by the user of the characteristics of the copy job comprises receiving explicit selection by the user of one or more of the characteristics, such that the user explicitly selects the one or more of the characteristics.

10. The method of claim 1, wherein the electronic file digitally representing the images on the media sheets comprises a portable data format (PDF) file.

11. The method of claim 1, wherein causing the electronic file to be printed based on the characteristics of the copy job as implicitly or explicitly selected by the user comprises printing the electronic file where the given tray is a physical tray of the scanning device, such that the scanning device is also a printing device and such that the scanning device has both scanning and printing functionality, the scanning device having specific printing capabilities.

12. The method of claim 1, wherein causing the electronic file to be printed based on the characteristics of the copy job as implicitly or explicitly selected by the user comprises, where the given tray is a particular virtual tray of the scanning device, transmitting the electronic file to the printing device having the physical tray to which the particular virtual tray corresponds, such that the printing device prints the electronic file.

13. The method of claim 1, wherein causing the electronic file to be printed based on the characteristics of the copy job as implicitly or explicitly selected by the user comprises, where the given tray is an automatic tray of the scanning device:
selecting without any user interaction a particular tray of the group of trays, so that media sheets loaded into the particular tray correspond to the characteristics of the copy job as implicitly or explicitly selected by the user, and so that a particular printing device of which the particular tray is physically a part has specific printing capabilities corresponding to the characteristics of the copy job as implicitly or explicitly selected by the user; and,
where the particular printing device is other than the scanning device, transmitting the electronic file to the particular printing device such that the printing device prints the electronic file.

14. The method of claim 13, wherein causing the electronic file to be printed based on the characteristics of the copy job as implicitly or explicitly selected by the user further comprises, where the given tray is an automatic tray of the scanning device:
where the particular printing device is the scanning device, printing the electronic file.

15. The method of claim 14, wherein selecting without user interaction the particular tray of the group of trays comprises:
where both a first tray and a second tray of the group of trays each has media sheets loaded thereinto that correspond to the characteristics of the copy job,
where both a first printing device of which the first tray is physically a part and a second printing device of which the second tray is physically a part each has specific printing capabilities corresponding to the characteristics of the copy job, and
where the first printing device is the scanning device and the second printing device is a printing device other than the scanning device,
selecting the first tray as the particular tray.

16. The method of claim 1, wherein the user is a first user, and the method further comprises receiving manual configuration by a second user of each tray of the group of trays, the second user configuring for each tray one or more of the attributes of media sheets loaded into the tray and the specific printing capabilities of the printing device of which the tray is physically a part, and
wherein the first user is different than or identical to the second user.

17. The method of claim 1, wherein the user is a first user, and the method further comprises configuring without any user interaction each tray of the group of trays, and
wherein configuring without any user interaction each tray of the group of trays comprises, for each virtual tray of the group of trays, querying the printing device having the physical tray to which the virtual tray corresponds to receive the attributes of media sheets loaded into the physical tray and the specific printing capabilities of the printing device.

18. A scanning device comprising:
a user interface mechanism to receive implicit or explicit selection by a user of a given tray of the scanning device in relation to which a copy job initiated at the scanning device is to be printed, the user interface mechanism further to receive implicit or explicit selection by the user of characteristics of the copy job,
the given tray associated with attributes of media sheets loaded into the given tray, the given tray associated with specific printing capabilities of a printing device of which the given tray is physically a part,
the given tray selected from a group of trays comprising at least one or more virtual trays, each virtual tray corresponding to a physical tray of a printing device other than the scanning device and to which the scanning device is communicatively connected,
the characteristics selected from a group of characteristics encompassing all characteristics supported by the given tray implicitly or explicitly selected by the user;
a scanning mechanism to scan one or more media sheets loaded into the scanning mechanism, the media sheets having images already formed thereon such that the scanning the media sheets yields an electronic file digitally representing the images on the media sheets; and,
a cause-printing mechanism to cause the electronic file to be printed based on the characteristics of the copy job as implicitly or explicitly selected by the user, the electronic file printed on media sheets loaded into the given tray implicitly or explicitly selected by the user.

19. The scanning device of claim 18, further comprising:
a printing mechanism having one or more physical trays, such that the scanning device is also a printing device and such that the scanning device has both direct scanning and direct printing functionality, the scanning device having specific printing capabilities; and,
a communication mechanism, such that for each virtual tray, the scanning device is communicatively connected to the printing device having the physical tray to which the virtual tray corresponds in that the scanning device is able to directly communicate with the printing device without an intermediary computer device between the scanning device and the printing device.

20. A computer-readable medium having one or more computer programs stored thereon to cause a scanning device to perform a method comprising:
receiving implicit or explicit selection by a user of a given tray of the scanning device in relation to which a copy job initiated at the scanning device is to be printed,
the given tray associated with attributes of media sheets loaded into the given tray, the given tray associated with specific printing capabilities of a printing device of which the given tray is physically a part,
the given tray selected from a group of trays comprising at least one or more virtual trays, each virtual tray corresponding to a physical tray of a printing device other than the scanning device and to which the scanning device is communicatively connected;
receiving implicit or explicit selection by the user of characteristics of the copy job, the characteristics selected from a group of characteristics encompassing all characteristics supported by the given tray implicitly or explicitly selected by the user;
scanning one or more media sheets loaded into the scanning device, the media sheets having images already formed thereon such that scanning the media sheets yields an electronic file digitally representing the images on the media sheets; and,
causing the electronic file to be printed based on the characteristics of the copy job as implicitly or explicitly selected by the user, the electronic file printed on media sheets loaded into the given tray implicitly or explicitly selected by the user.
